(19) United States
(12) Patent Application Publication
(10) Pub. No.: US 2025/0163590 A1
(43) Pub. Date: May 22, 2025

(54) ELECTROCHEMICAL PRODUCTION OF LITHIUM HYDROXIDE

(71) Applicant: THE JOHNS HOPKINS UNIVERSITY, Baltimore, MD (US)

(72) Inventors: Chao Wang, Baltimore, MD (US); Fei Xu, Baltimore, MD (US); Guangye Zhou, Baltimore, MD (US)

(21) Appl. No.: 18/841,303

(22) PCT Filed: Feb. 24, 2023
(86) PCT No.: PCT/US2023/063257

§ 371 Date: Aug. 23, 2024

(51) Int. Cl. C25B 1/46; C25B 9/19; C25B 11/097; C25B 13/05; C25B 15/08

(52) U.S. Cl. CPC C25B 1/46; C25B 9/19; C25B 11/097; C25B 13/05; C25B 15/083

(57) ABSTRACT

Disclosed herein are compositions, devices, and methods for producing lithium hydroxide by electrochemical extraction of lithium from lithium-containing solutions, including unconventional sources that have low lithium content, such as brine and seawater.

### CROSS-REFERENCE TO RELATED APPLICATIONS

This application claims priority to and the benefit of U.S. Provisional Patent Application No. 63/314,084, filed on Feb. 25, 2022, which is incorporated herein by reference in its entirety.

### TECHNICAL FIELD

Disclosed herein are compositions, devices, and methods for producing lithium hydroxide by electrochemical extraction of lithium from lithium-containing solutions, including unconventional sources that have low lithium content, such as brine and seawater.

### BACKGROUND

In recent years, the importance of lithium (Li) has increased due to its wide usage in Li-ion batteries (LIBs) and other homeland security applications. According to the latest USGS report, about 35% of the global lithium supply is from minerals, especially spodumene, and the remaining ˜65% originates from Li-rich brines. Due to increasing demand, it is projected that such traditional Li sources will not meet the need for battery supply and alternative sources, such as seawater, geothermal brines, and mine tailings need to be explored. Based on the market projection, the increasing adoption of higher-nickel LIB cathode material, particularly in passenger EV batteries, will drive demand for LiOH faster than Li₂CO₃. Current LiOH production, however, frequently requires a secondary electrodialysis and crystallization recovery process from Li₂CO₃.

In recent years, extraction techniques have been widely studied. The traditional Li extraction process typically involves cumbersome procedures, such as high-temperature calcination, thermal evaporation, and extensive use of expensive and toxic chemicals, causing high energy and water consumption, concerns about environmental compatibility, large space footprint, and low-cost effectiveness. Moreover, such methods are unlikely to apply to the alternative sources containing much lower Li concentrations (e.g., ˜100-1500 ppm).

Lithium extraction from seawater is an extremely challenging process because of lithium's trace amount (˜0.2 ppm) in the ocean water. Electrochemical extraction of lithium cations, ideally powered by renewable electricity, has attracted significant attention for the mining of Li⁺ from brines and seawater, with great potential to achieve high energy efficiency, be environment-friendly, and accommodate distributed field operations. Previous studies are typically based on the intercalation of LIB cathode materials or cation exchange membrane (CEM) electrodialysis. The LIB cathode materials can selectively absorb lithium ions from the electrolyte because of the well-defined ionic channel dimensions. Several cathode materials known for Li-ion batteries, including Lithium iron phosphate (LiFePO₄, or LFP) and lithium manganese oxide (LiMn₂O₄, or LMO), have been widely studied for Li⁺ extraction via electrochemical intercalation processes in a non-membrane cell. Li in unconventional sources, however, often coexists with alkali (Na⁺ and K⁺) and alkaline earth (Mg²⁺, Ca²⁺, etc.) cations. Because of the similar chemical properties of these impurity cations to Li⁺, they also can intercalate into the various cathode materials to certain extents, leading to the need for expensive and energy-intensive downstream purification. Moreover, the reversible intercalation of Li⁺ requires two separate processes, which has hindered the scaling up of this approach for Li extraction. Electrodialysis employing polymer cation-exchange membranes (such as Nafion-117) have been extensively studied. This approach also has been suffering from the Na⁺ impurities, as it can also migrate through the CEM during the electrolysis process.

In addition to utilizing LTB cathode materials and CEM electrodialysis, there are research efforts to develop SSE-based electrochemical lithium extraction processes such as NASICON, Li₁₊ₓAlₓGe₂₋ₓ(PO₄)₃ (LAGP) (Yang et al. Joule 2018, 2(9), 1648-1651) and Garnet Li₇La₃Zr₂O₁₂ (LLZO) (Zhao e al. Chem. Commun. 2020, 10, 1577-1580; Zhang et al. J. Power Sources 2021, 482, 228938). The performance, however, still needs to be significantly improved. In these works, the electrochemical cell was divided into two parts by the SSE with seawater on the anode side and organic electrolyte on the cathode side. The electrochemical reactions that occur on both electrodes are chlorine evolution reaction (ClER) and lithium metal deposition reaction, and Li⁺ will move through the SSE from the anode toward the cathode chamber. However, due to lithium's low standard reduction potential (−3.05V vs. SHE), the extraction process requires very high operating voltage (>5V).

### SUMMARY

A more efficient Li extraction technology with lower energy consumption would significantly decrease the cost of such Li production process to achieve industrial application. Disclosed herein is such a process, along with an electrodialysis apparatus and related methods.

In one aspect, disclosed herein is an electrodialysis apparatus, comprising:
an anode chamber comprising an anode and an anolyte, wherein the anolyte is a solution comprising lithium cations and chloride anions;
a cathode chamber comprising a cathode and a catholyte, wherein the catholyte is a solution comprising lithium hydroxide;
a Li⁺-selective cation exchange membrane operationally disposed between the anode chamber and the cathode chamber; and
a power source.

In some embodiments, the anolyte solution comprises lithium chloride, lithium sulfate, lithium carbonate, lithium phosphate, lithium hexafluorophosphate, lithium perchlorate, lithium bis(trifluoromethanesulfonyl)imide, or a mixture thereof. In some embodiments, the anolyte is brine or seawater.

In some embodiments, the anode comprises an IrRu mixed-metal oxide.

In some embodiments, the Li⁺-selective cation exchange membrane comprises a lithium aluminum germanium phosphate.

In some embodiments, in the anode chamber, the chloride ions are oxidized to chlorine gas. In some embodiments, in the cathode chamber, water is reduced to hydrogen gas and hydroxide ions. In some embodiments, the cathode chamber does not comprise an organic electrolyte.

In some embodiments, the anode chamber further comprises an inlet for the anolyte and an outlet for spent anolyte. In some embodiments, the cathode chamber further comprises an inlet for the catholyte and an outlet for a product lithium hydroxide solution.

In some embodiments, the power source is a source of renewable energy selected from solar energy or wind energy.

In one aspect, disclosed herein is a method of producing lithium hydroxide, comprising:
providing an electrodialysis apparatus comprising an anode chamber, a cathode chamber, and a Li⁺-selective cation exchange membrane operationally disposed between the anode chamber and the cathode chamber, wherein the anode chamber comprises an anode and the cathode chamber comprises a cathode;
supplying an anolyte comprising lithium cations and chloride anions to the anode chamber;
supplying a catholyte to the cathode chamber; and
applying an electric potential to the electrodialysis apparatus via a power source, to thereby produce lithium hydroxide in the cathode chamber.

In some embodiments, the anolyte is a solution comprising lithium chloride, lithium sulfate, lithium carbonate, lithium phosphate, lithium hexafluorophosphate, lithium perchlorate, lithium bis(trifluoromethanesulfonyl)imide, or a mixture thereof. In some embodiments, the anolyte is brine or seawater.

In some embodiments, the anode comprises an IrRu mixed-metal oxide.

In some embodiments, the Li⁺-selective cation exchange membrane comprises a lithium aluminum germanium phosphate.

In some embodiments, in the anode chamber, the chloride ions are oxidized to chlorine gas. In some embodiments, in the cathode chamber, water is reduced to hydrogen gas and hydroxide ions. In some embodiments, the cathode chamber does not comprise an organic electrolyte.

In some embodiments, the method further comprises removing spent anolyte from the anode chamber. In some embodiments, the method further comprises removing a product lithium hydroxide solution from the cathode chamber. In some embodiments, the method further comprises isolating the lithium hydroxide from the product solution via evaporation or precipitation.

In some embodiments, the power source is a source of renewable energy selected from solar energy or wind energy.

In some embodiments, the method further comprises isolating the chlorine gas from the anode chamber and/or isolating the hydrogen gas from the cathode chamber.

### BRIEF DESCRIPTION OF THE DRAWINGS

FIG. 1 shows a scheme of an electrochemical system for producing lithium hydroxide.

FIG. 2 shows XRD results of LAGP powder, Pristine LAGP membrane, and post long-term reaction LAGP membrane.

FIG. 3A and FIG. 3B show: (FIG. 3A) SEM image and (FIG. 3B) EDX result of the mixed-metal oxide (MMO) that was used as a chlorine evolution reaction cathode material.

FIG. 4A and FIG. 4B show electrochemical performance in artificial solutions with different Li concentrations, with the reaction performed at 0.25 mA/cm².

FIG. 5 shows linear scan voltammetry curves for half and full reactions.

FIG. 6 shows a photo of a flow cell according to the disclosure.

FIG. 7 shows results of a long-term test of one LAGP membrane in Chile Brine at different operation current densities (0.20-0.50 mA cm²).

FIG. 8A and FIG. 8B show: (FIG. 8A) data showing Faradic efficiency and energy efficiency; and (FIG. 8B) data showing partial current density of Li extraction and corresponding LiOH production rate at different operation current densities.

FIG. 9A and FIG. 9B show: (FIG. 9A) data showing selectivities for different cations; (FIG. 9B) galvanic performance and Faradic efficiency of Li extraction.

FIG. 10 shows a photo, intersection SEM, and EDX of LAGP membrane before and after reaction. The reactor was performed in Chilean brine at 0.25 mA/cm².

FIG. 11A and FIG. 11B show: (FIG. 11A) results of a long-term test of one LAGP membrane in Salton Sea Brine at 0.25 mA/cm²; and (FIG. 11B) results of a long-term test of one LAGP membrane in seawater at 0.25 mA/cm².

FIG. 12A and FIG. 12B show: (FIG. 12A) Faradic efficiency and energy efficiency in different Li sources; and (FIG. 12B) comparison of partial current density of Li extraction and corresponding LiOH production rate.

FIG. 13A and FIG. 13B show: (FIG. 13A) the energy cost per metric ton LiOH under different current efficiencies and electricity prices; and (FIG. 13B) the estimated lithium hydroxide production cost per metric ton under different current densities.

FIG. 14A and FIG. 14B show: (FIG. 14A) the estimated net present value of proposed lithium extraction process running at the target current density; and (FIG. 14B) the capital cost and operating cost breakdown of proposed lithium extraction process running at the target current density.

### DETAILED DESCRIPTION

Disclosed herein is an apparatus and method for electrochemical extraction of lithium from unconventional sources, such as brine or seawater, by integrating lithium electrodialysis with the chlor-alkali process. The apparatus and method comprises an electrodialysis system having two reactions: oxidation of chloride ion to chlorine gas on the anode side (R1), and reduction of water to hydrogen gas and hydroxide ions on the cathode side (R2). The reactions are illustrated in Scheme 1.

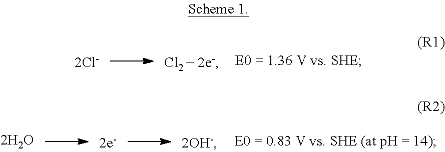

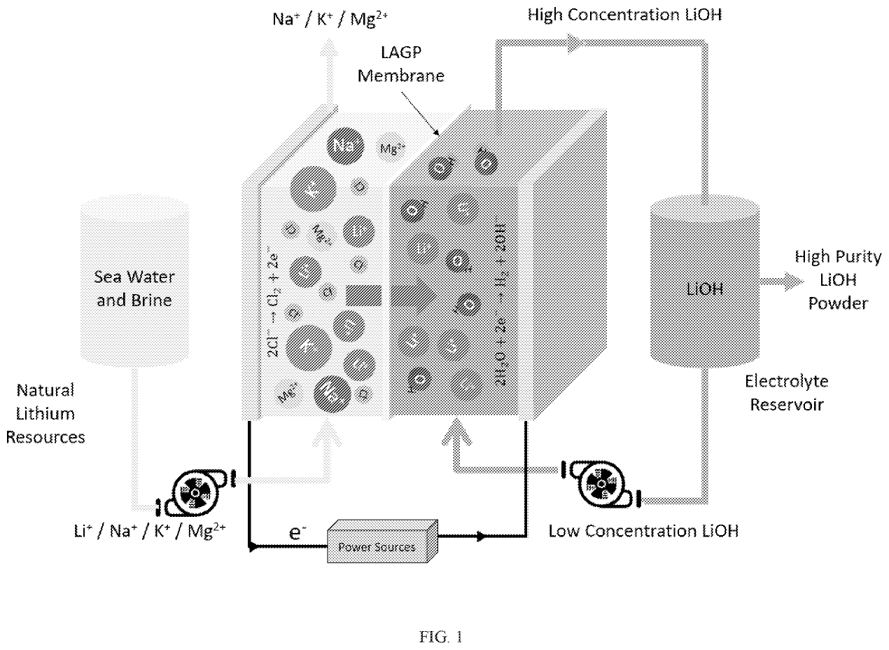

By employing a Li⁺-selective cation-exchange membrane in the electrodialysis system, the Li⁺ cations migrate from the anode side to the cathode side to recombine with the OH⁻ released from water to form LiOH. The membrane allows for Li⁺ permeation but blocks the crossover of other cations (H⁺, Na⁺, K⁺, Mgz⁺, Caz⁺, etc.). The resulting concentrated aqueous solution of LiOH can further be subjected to evaporation/precipitation to produce solid LiOH. LiOH is a more valuable feedstock than Li₂CO for the manufacturing of cathode materials for LIBs, however, if required the LiOH could be reacted further with CO₂ from air to form Li₂CO₃. The H₂ and Cl₂ gases generated as byproducts can be isolated and used in other applications, e.g., to power fuel cells and to produce bleach, respectively, as established for the commercial chlor-alkali electrolysis process. The electrodialysis system can, in some embodiments, be powered by renewable energy sources, such as solar or wind power. An exemplary apparatus and method is shown in FIG. 1.

Accordingly, disclosed herein is an electrodialysis apparatus, comprising: an anode chamber comprising an anode and an anolyte, wherein the anolyte is a solution comprising lithium cations and chloride anions; a cathode chamber comprising a cathode and a catholyte, wherein the catholyte is a solution comprising lithium hydroxide; a Li⁺-selective cation exchange membrane operationally disposed between the anode chamber and the cathode chamber; and a power source.

One element of the electrodialysis apparatus is the anode chamber, which houses the anode and the anolyte. The reaction that occurs in the anode chamber is the oxidation of chloride anions in the anolyte to chlorine gas, as shown in Scheme 1 (referred to herein as the “chlorine evolution reaction” or “ClER”). As such, the anode comprises a material that acts as a catalyst for chlorine reduction. This material should be suitably stable to avoid any corrosion issues resulting from chlorine gas production. In some embodiments, the anode comprises a metal selected from Ir, Ru, Ti, Pt, Ta, Sn, Nb, Sb, Zr, Pb, Mn, Ce, or any combination thereof. In some embodiments, the anode comprises an oxide of a metal selected from Ir, Ru, Ti, Pt, Ta, Sn, Nb, Sb, Zr, Pb, Mn, Ce, or any combination thereof. In some embodiments, the anode comprises an Ir—Ru mixed-metal oxide (MMO). Such a material is described, for example, in Goudarzi et al. J. Sol-Gel Sci. Techn. 79, no. 1 (2016): 44-50. The anolyte is a solution that includes lithium cations and chloride anions. The source of lithium cations can be any suitable lithium salt, such as lithium chloride, lithium sulfate, lithium carbonate, lithium phosphate, lithium hexafluorophosphate, lithium perchlorate, lithium bis(trifluoromethanesulfonyl)imide, or other lithium salts, or mixtures of any thereof. In some embodiments, the source of lithium cations is lithium chloride. In some embodiments, the anolyte is an aqueous solution comprising lithium cations and chloride anions. In some embodiments, the anolyte is brine or seawater. In some embodiments, the anolyte is sea water. In some embodiments, the anolyte is water from a salt lake. In some embodiments, the anolyte is a brine. In some embodiments, the anolyte is a geothermal brine. The concentration of lithium cations in seawater is low (an average of about 0.1-0.2 ppm or about 14-29 μM), whereas the concentration in brine can be higher (e.g., about 100 ppm to about 3000 ppm, or about 0.010 M to about 0.50 M). For example, the Examples herein disclose testing with a brine from the Salar de Atacama, Chile (about 0.23 M) and from the Salton Sea in California (about 0.024 M). Accordingly, the concentration of lithium cations in the anolyte can be from about 0.1 ppm to about 3000 ppm, or from about 0.0001 M to about 0.50 M.

Another element of the electrodialysis apparatus is the Li⁺-selective cation exchange membrane. With use of such a membrane, the Li⁺ cations migrate from the anode chamber to the cathode chamber to combine with the OH⁻ released from water and form LiOH. With the Li⁺ selectivity, the membrane allows for Li⁺ permeation but blocks the crossover of other cations that may be present in the anolyte (H⁺, Na⁺, K⁺, Mg²⁺, Ca²⁺, etc.). Any suitable Li⁺ selective membrane can be used. In some embodiments, the membrane comprises a lithium aluminum germanium phosphate (LAGP). In some embodiments, the membrane comprises a LAGP having formula Li₁₋ₓAlₓGe₂₋ₓ(PO₄)₃, where x is a number from 0 to 2 (see, e.g., Yang et al. Joule 2018, 2(9), 1648-1651). For example: if x is 1, then the LAGP has the formula LiAlGe(PO₄)₃; if x is 0.5, then the LAGP has the formula Li_{1.5}Al_{0.5}Ge_{1.5}(PO₄)₃. The value of x can be any number from 0 to 2 (e.g., 0, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, or 2, or any value therebetween). In some embodiments, the membrane comprises a material of formula Li₁₊ₓMₓTi₂₋ₓ(PO₄)₃, wherein x is a number from 0 to 2 (e.g., 0, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, or 2, or any value therebetween), and M is a trivalent metal ion, such as Al³⁺, Cr³⁺, Ga³⁺, Fe³⁺, Sc³⁺, In³⁺, Lu³⁺, Y³⁺, or La³⁺. The Li⁺-selective cation exchange membrane can be prepared by methods known in the art. Other Li⁺-selective membranes can also be used, such as Garnet-type electrolytes, which are classified into several groups including Li3 (Li₃Ln₃Te₂O₁₂, wherein Ln=Y, Pr, Nd, etc.), Li5 (Li₅La₃M₃O₁₂, wherein M=Nb, Ta, Sn, etc.), Li6 (Li₆ALa₂M₂O₁₂, wherein A=Ca, Sr, Ba, etc., and M=Nb, Ta, etc.), and L7 (Li₇La₃M₂O₁₂, wherein M=Zr, Sn, Hf, etc.). Another example is a perovskite-type Li-ion solid electrolyte, such as a three-component oxide system Li₃ₓLa_{2/3-x}TiO₃ (0<x<0.16) (LLTO) or a four-component oxide system (Li, Sr)(B, B′)O3 (B=Zr, Hf, Ti, Sn, Ga, etc., B′=Nb, Ta, etc.).

Another element of the electrodialysis apparatus is the cathode chamber, which houses the cathode and the catholyte. The reaction that occurs in the cathode chamber is the reduction of water to hydrogen and hydroxide anions, as shown in Scheme 1 (referred to herein as the “hydrogen evolution reaction” or “HER”). In some embodiments, the cathode material is platinum. The catholyte comprises lithium hydroxide, formed as a result of the reduction reaction and its combination with the lithium cations that migrate through the membrane from the anode chamber. The concentration of lithium hydroxide varies during the electrodialysis process, starting at a lower concentration and ending at a higher concentration. In some embodiments, the concentration of lithium hydroxide in the catholyte ranges from 0.1 M to about 10 M.

In some embodiments, the cathode chamber does not comprise an organic electrolyte. In some embodiments, the catholyte consists essentially of water and lithium hydroxide.

The electrodialysis apparatus further comprises a power source. Any suitable power source can be used, but in some embodiments, the power source is a source of renewable energy, such as solar power or wind energy. In some embodiments, the power source is a solar panel.

In some embodiments, the anode chamber further comprises an inlet for the initial anolyte and an outlet for spent anolyte. For example, in some embodiments, the anode chamber comprises an inlet for the initial anolyte (e.g., sea water or brine), and after operation of the electrodialysis apparatus to produce a sufficient amount of lithium hydroxide in the cathode chamber, the spent anolyte (depleted of Li⁺ ions) can be removed via the outlet and replaced with fresh anolyte.

Similarly, in some embodiments, the cathode chamber further comprises an inlet for the catholyte and an outlet for a product lithium hydroxide solution. For example, in some embodiments, after operation of the electrodialysis apparatus, the catholyte will comprise a high concentration of lithium hydroxide, which can be removed via the outlet such that the lithium hydroxide can be isolated. Fresh catholyte can be added via the inlet.

In accordance with the disclosure, the electrodialysis apparatus described herein can be used in a method of producing lithium hydroxide. In some embodiments, the apparatus can produce lithium hydroxide with a selectivity of over about 99%, e.g., over about 99.1%, 99.2%, 99.3%, 99.4%, 99.5%, 99.6%, 99.7%, 99.8%, or 99.9%. The selectivity can be determined, for example, using inductively coupled plasma (ICP) analysis.

Also disclosed herein is a method of producing lithium hydroxide, comprising: providing an electrodialysis apparatus comprising an anode chamber, a cathode chamber, and a Li⁺-selective cation exchange membrane operationally disposed between the anode chamber and the cathode chamber, wherein the anode chamber comprises an anode and the cathode chamber comprises a cathode; supplying an anolyte comprising lithium cations and chloride anions to the anode chamber; supplying a catholyte to the cathode chamber; and applying an electric potential to the electrodialysis apparatus via a power source, to thereby produce lithium hydroxide in the cathode chamber. In the disclosed method, the anode chamber, cathode chamber, the Li⁺-selective cation exchange membrane, the anolyte, the catholyte, and the power source are the same as those described above (i.e. all embodiments of these elements described in relation to the apparatus, and any combination thereof, can be used in the methods disclosed herein).

In some embodiments, the method further comprises removing spent anolyte from the anode chamber. In some embodiments, the method further comprises supplying fresh anolyte to the anode chamber. In some embodiments, the method further comprises removing a product lithium hydroxide solution from the cathode chamber. In some embodiments, the method further comprises supplying fresh catholyte to the cathode chamber.

In some embodiments, the method further comprises isolating the lithium hydroxide from the product solution. The lithium hydroxide can be isolated via any suitable method, such as evaporation or precipitation.

The following examples further illustrate aspects of the disclosure but, of course, should not be construed as in any way limiting its scope.

### EXAMPLES

### Experimental Materials and Methods

Materials and Chemicals. Lithium Chloride (LiCl, ≥95%, Sigma Aldrich), Sodium Chloride (NaCl, ≥95%, Fisher Scientific), Potassium Chloride (KCl, ≥95%, Fisher Scientific), Magnesium Chloride Hexahydrate (MgCl₂·6H₂O, >95%, Fisher Scientific), Lithium Hydroxide Monohydrate (LiOH·H₂O, 99.95%, Sigma Aldrich), Ruthenium(III) Chloride (RuCl₃, 99.9% Fisher Scientific), Iridium(III) Chloride Hydrate (IrCl₂·xH₂O, ≥95%, Sigma Aldrich), Lithium, Sodium, Potassium, and Magnesium Standard solutions for ICP (1000 mg/L) were purchased from Sigma Aldrich. Li_{1.5}Al_{0.5}Ge_{1.5}(PO₄)₃ (LAGP) powder was purchased from MSE Supplies. Seawater was obtained from the Inner Harbor of Baltimore City, Maryland. Filter membranes with 0.2 μm pore size were purchased from Sigma Aldrich. Deionized (DI) Water (Resistance >18.2 MΩ cm) was used throughout this work.

LAGP Membrane preparation procedure. The LAGP powder (500 mg) was dry pressed with 10 tons of pressure for at least 3 minutes. The resulting white disc was sintered at 800° C. for 6 hours with programmed heating and cooling ramping rates of 1° C.·min⁻¹. Prior to the electrochemical test, the sintered LAGP pellets were to obtain a smooth surface.

Fabrication of mixed-metal oxide (MMO). The IrO₂/RuO₂-coated titanium screen was synthesized by a modified method in literature (Wen et al. (1992) J. Electrochem. Soc. 139(8), 2158) and used as anode catalyst for the chlorine evolution reaction (ClER). The titanium screen was cleaned in boiling 0.5 mol/L oxalic acid for 60 mins. The screen was then dip coated in an iso-propanol solution with 10% hydrochloric acid, 0.125 mol/L IrCl₃ and 0.125 mol/L RuCl₃. The dip coated screen was dried in an oven at 100° C. for 15 mins. The procedure of dip coating and drying was repeated for 5 times before the final annealing. After drying, the catalysts were annealed under air flow at 500° C. for 60 min.

Material Characterization. Scanning electron microscopy (SEM) and the elemental distribution of the LAGP pellet was performed with a Hitachi HD2700C Scanning Transmission Electron Microscope with Energy-dispersive spectroscopy mapping (EDS). X-ray Diffraction (XRD) was performed on a Bruker D8 Advance with Cu Ka radiation. Inductively coupled plasma mass spectrometry (ICP-MS) was performed on a PerkinElmer NexION 300D.

Electrochemical Tests. The LAGP pellet was polished using Alumina Slurry and rinsed with DI water and ethanol several times. The electrochemical measurements were performed on an Autolab PGSTAT302N potentiostat (Metrohm) equipped with a FRA32M module. A platinum wire was used as the cathode electrode; a self-made MMO was used as the anode electrode. The cathode and anode chamber were separated by a LAGP pellet, which minimizes the permeability of ions other than lithium. 20 L Seawater collected from the Inner Harbor of Baltimore was vacuumed filtered through a 0.2 μm filter to remove particles and microorganisms. Lithium extraction was carried out in a house-made flow cell. During the experiments, A solution of 0.1M LiOH was used as the electrolyte in the cathode chamber, and artificial brines or seawater was used as the electrolyte in the anode chamber. Both electrolytes were flown through the cathodic and anodic compartments of the flow cell by using a peristaltic pump. For experiments with artificial brines, the electrolytes are cycling at 50 sccm, and for seawater is cycling at 100 sccm rate. The electrolytes were sampled at every 1 hour of test, and the lithium concentration was determined by ICP-MS. To ensure the accuracy of ICP results, R²=0.9999 was obtained for the calibration curves of all elements (Li⁺, Na⁺, K⁺, and Mg²⁺).

Calculation of the net present value (NPV) for a 1 kTon annual production lithium extraction process assuming a production rate of 1000 MT/year:

$$Power = Operating Voltage * Operating Current Density$$

$$Extraction Speed = \frac{23.95 g}{mol} * Current Density * \frac{mol}{96485 C} * Efficiency$$

$$Annual Extraction Energy Cost = 1000 \frac{Ton}{year} * \frac{Power * Total Electrolyzer Area * 1 year}{Extraction Speed} * Electricity Price$$

### Example 1: Exemplary Apparatus and Method

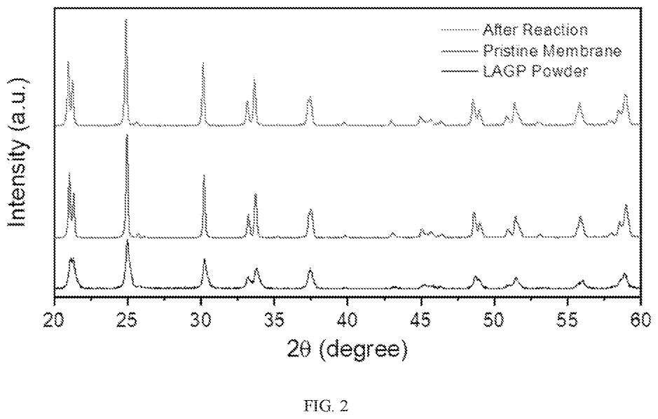

The solid-state electrolyte membrane was prepared by a previously reported compression-calcination approach (see the Experimental Methods above). From the X-ray diffraction patterns (XRD, FIG. 2), after calcination at 800° C. for 6 h, the membrane exhibits a higher crystallinity than commercial LAGP powders, while there are two small peaks of pristine LAGP membrane at 2θ=23° and 2θ=26°, which can be respectively attributed to the formation of AlPO₄ and GeO₂ during calcination at high temperature (Guo et al. ACS App. Mater. Inter. 2017, 9(48):41837-41844).

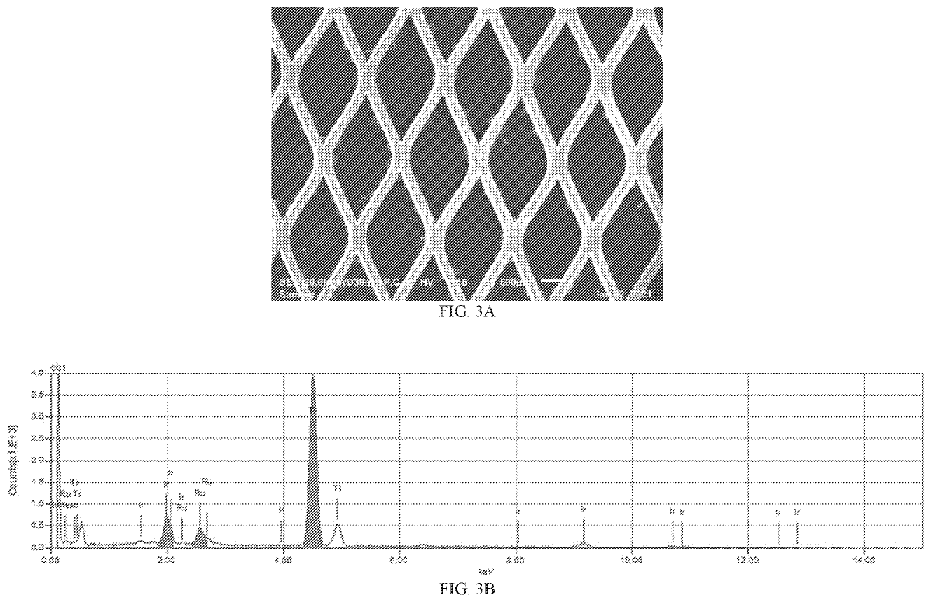

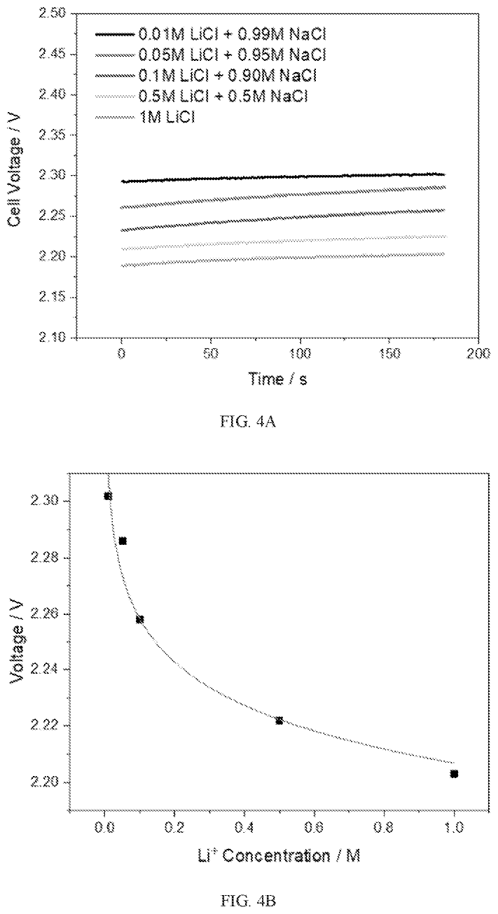

To elucidate the feasibility of the designed system for selective lithium extraction, the LAGP membrane was firstly sealed into an H-type electrolyzer for the preliminary electrochemical study. Before integration, the LAGP membrane was cleaned by extensive polishing and then washing with deionized water and ethanol to remove the impurities on the surface. The mixed solution with different LiCl concentrations balanced by NaCl was used as the model anolyte (total cation concentration is 1M), while the catholyte is 1M LiOH, for exploring the Li concentration effect on the electrochemical performance. IrRu mixed-metal oxide (MMO, see Experimental Methods above) is considered to be an excellent catalyst for the chlorine evolution reaction (ClER) due to its high stability and activity (Goudarzi 2016), and thus employed as the anode in this example to prevent corrosion issues resulting from the evolved chlorine. The SEM images (FIG. 3A) and energy-dispersive X-ray (EDX) spectroscopy (FIG. 3B) showed that both Ir and Ru were well dispersed onto Ti mesh with around 5% atomic loading amount. Considering the possible side reaction on LAGP at high current density, the operations were firstly performed in an anolyte with different Li concentrations at 0.25 mA·cm⁻². As shown in FIG. 4A, the cell voltage is gradually uphill when lithium concentration decreasing, while this trend is contrasting for sodium, indicating the high dependence on lithium concentration. Moreover, the cell voltage also showed a logarithmic relationship for the lithium concentration (FIG. 4B). The cell voltage was maintained at about 2.3V when the lithium concentration was even as low as 0.01M, illustrating the capacity to extract lithium from diluted sources with relatively lower energy consumption.

Compared with the ordinary polymer-based membranes, the introduction of LAGP SSE will certainly cause an increase in overpotential because of its higher ions' diffusion resistance. The total cell voltage is determined by the potential difference between anodic and cathodic reactions and the overpotential induced by the membrane:

$${E}_{total} = {E}_{anode} - {E}_{cathode} + {η}_{membrane}$$

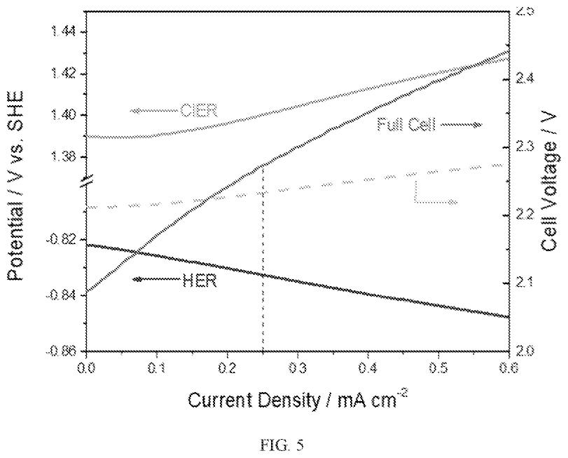

To ascertain the contribution of membrane, HER and ClER were independently studied by the linear scan voltammetry (LSV, FIG. 5) in a three-electrode system. In 1M LiOH solution as catholyte, the Hg/HgO reference electrode was used for alkaline HER, while the Ag/AgCl reference electrode was applied in the 1M LiCl as the anolyte for ClER under near-neutral conditions. Based on the LSV curves, the potentials of HER and ClER are −0.83 V and 1.40 V versus standard hydrogen electrode (SHE) at the current density of 0.25 mA·cm². In the two-electrodes system, however, the total cell voltage is 2.27 V. Thus, the overpotential caused by LAGP membrane is ˜0.04 V, which contributes almost 48% of the total.

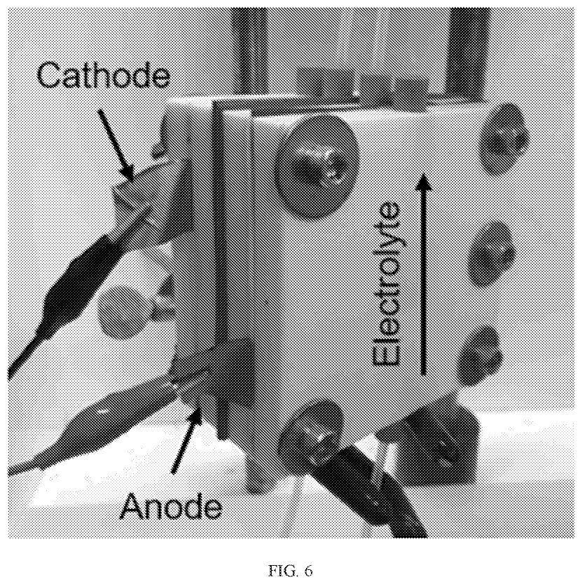

Only taking model solutions for electrochemical extraction, however, is insufficient. In addition to sodium, there are many other alkali metal and alkaline-earth metal cations like potassium and magnesium in common lithium sources that also will significantly reduce the efficiency of the traditional electrochemical lithium dialysis process. Furthermore, in such a batch reactor, the bubbles formed during HER and ClER, the diluting lithium concentration in the anolyte, as well as the exhaled corrosive chemicals, will induce the increasing cell voltage and the decreasing stability for long-term operation. Hence, a flow cell integrated with the LAGP membrane was developed (FIG. 6) to perform the extraction process in an artificial Chile Brine (CB, Table 1). The flow electrolyzer was fabricated from PTFE to prevent the disturbance of possible metal impurities. The LAGP membrane area and the electrode area of both anode and cathode were all set as 1 cm², and the concentration change of all cations was detected by inductively coupled plasma mass spectrometry (ICP-MS). Typically, in CB, the molar concentration ratios of lithium to sodium, potassium and magnesium are 0.056, 0.45 and 0.24, respectively. Although the concentration of lithium in CB is much less than other impurities, exclusively lithium extraction from CB with high selectivity and FE can still be achieved and more feasible than other polymer-based membranes since the crystal lattice of LAGP is mismatched for sodium, potassium, and magnesium ions, which will suppress the diffusion of impurity cations. Specifically, to ensure the accuracy of ICP-MS detection, the catholyte was replaced by 0.1M LiOH, and every experiment was repeated three times.

TABLE 1
The concentration of different cations in the artificial brines

| Ionic Concentration (mg/L) | Li⁺ | Na⁺ | K⁺ | Mg²⁺ |
|---|---|---|---|---|
| Salar de Atacama, Chile | 1,615 | 94,561 | 19,879 | 22,822 |
| Salton Sea, California | 170 | 58,000 | 12,000 | 84 |

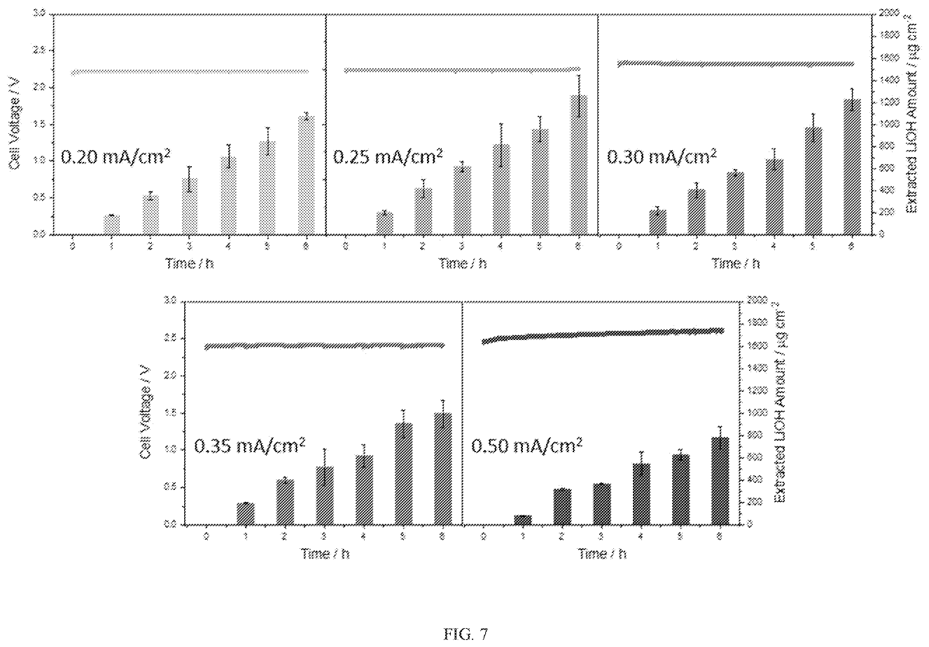

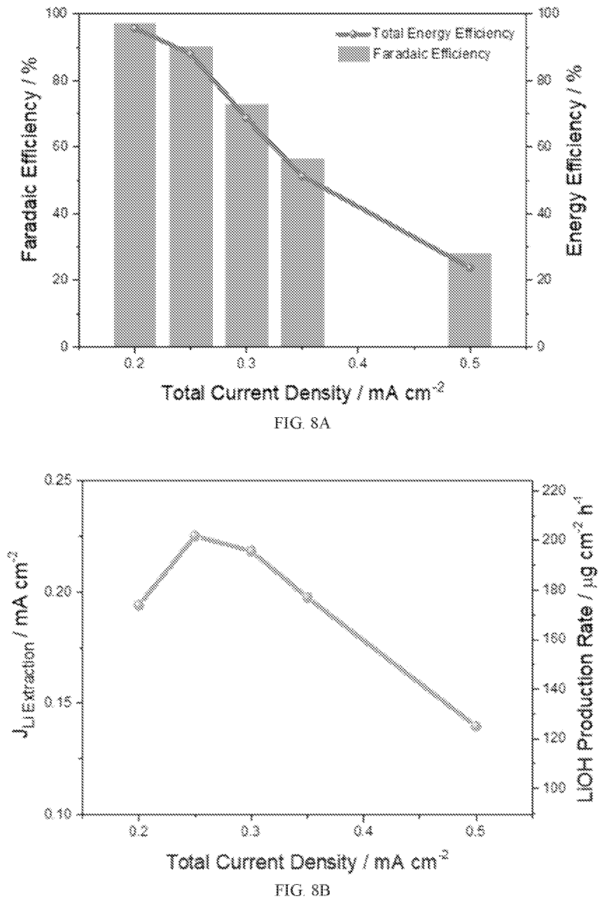

To explore the best operation conditions, the designed flow system was performed for a long-term test under different current densities (0.20-0.50 mA cm², for details, see the Experimental Methods above). As shown in FIG. 7, the cell voltage presents a stepped upward trend from 2.21 V to 2.58 V with increasing operation current density. Moreover, only one LAGP membrane also can exhibit remarkable stability of 30 h continuously testing at different operation currents. At 0.20 mA cm², the highest average FE of ˜97.1% can be obtained for LiOH production, and the total LiOH production rate can reach 1026.7 μg·cm⁻²_{membrane}. In contrast, after testing at 0.50 mA·cm⁻² for 6 h, the total LiOH production rate of 748.8 μg·cm⁻²_{membrane} was gained, which is only 72.9% of the productivity at 0.20 mA/cm². With higher current density, the specific Faradic efficiency (FE, calculated based on consumed electrons and extracted lithium ions as described above) of LiOH production was decreasing from ˜97.1% to ˜27.9%, as well as the corresponding energy efficiency (EE) was decreased from 95.7% to 23.8% (FIG. 8A, see calculation details above). For the specific performance, the partial current density of lithium extraction and the average LiOH production rate versus operation current density shows a volcano-like plot (FIG. 8B). The peak performance appears at 0.25 mA·cm⁻², where the best average LiOH production rate of 201.7 μg·cm⁻² h⁻¹ can be realized with a relatively high FE of 90.1%. After that, owing to the more and more severe side reactions, the average LiOH production rate decreases and maintains 125.2 μg·cm⁻² h⁻¹ at 0.50 mA·cm⁻².

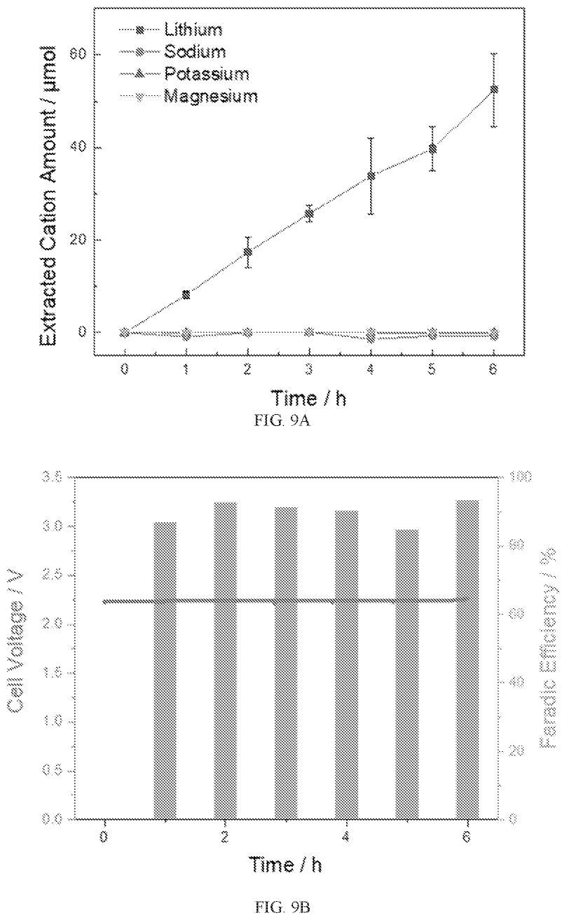

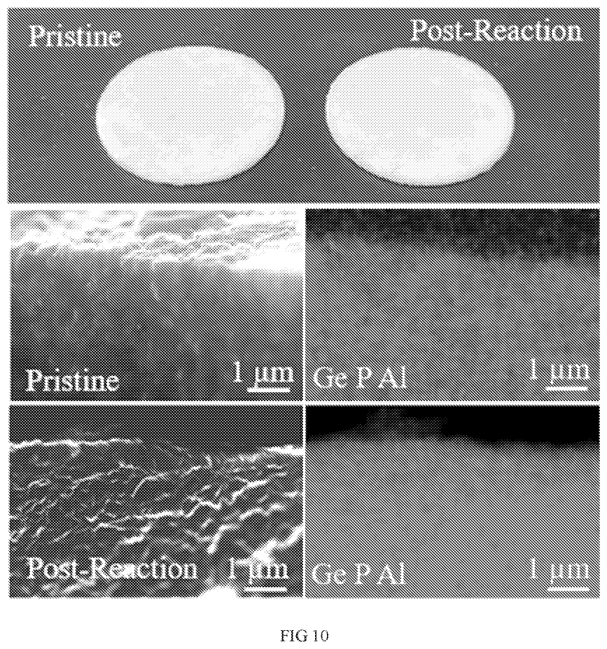

Desirably, after testing at 0.25 mA·cm⁻² for 6 h, the extracted lithium amount can reach 52.4 μmol·cm²_{membrane} (FIG. 9A), corresponding to an average FE of 93.4% for lithium extraction within 6 h operation (FIG. 9B). What should be emphasized is that the apparent concentration enhancement of Na⁺/K⁺/Mg²⁺ ions in the catholyte cannot be detected, demonstrating the diffusion pathway for other cations was prohibited except for lithium. Thanks to the flow system and stable electrodes, the operation cell voltage was maintained at ˜2.25V for 6 h without any performance degradation. Additionally, the structural stability of the LAGP membrane under harsh test conditions was also confirmed by SEM images and energy-dispersive X-ray (EDX) spectroscopy (FIG. 10). For the pristine LAGP membrane, the Al, Ge and P elements are still uniformly dispersed with the thickness of 600 μm, and after the long-term operation, there is no obvious surface or structural collapse and element loss on LAGP.

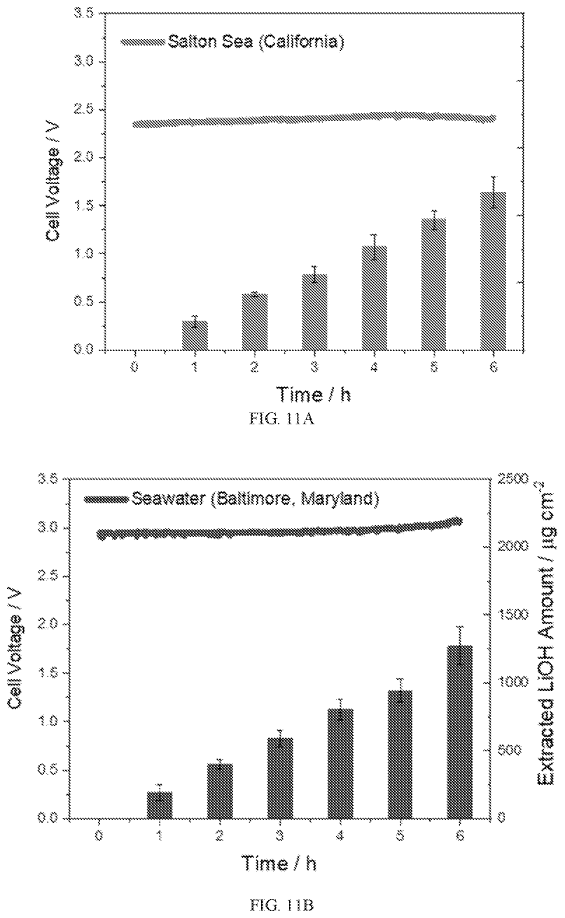

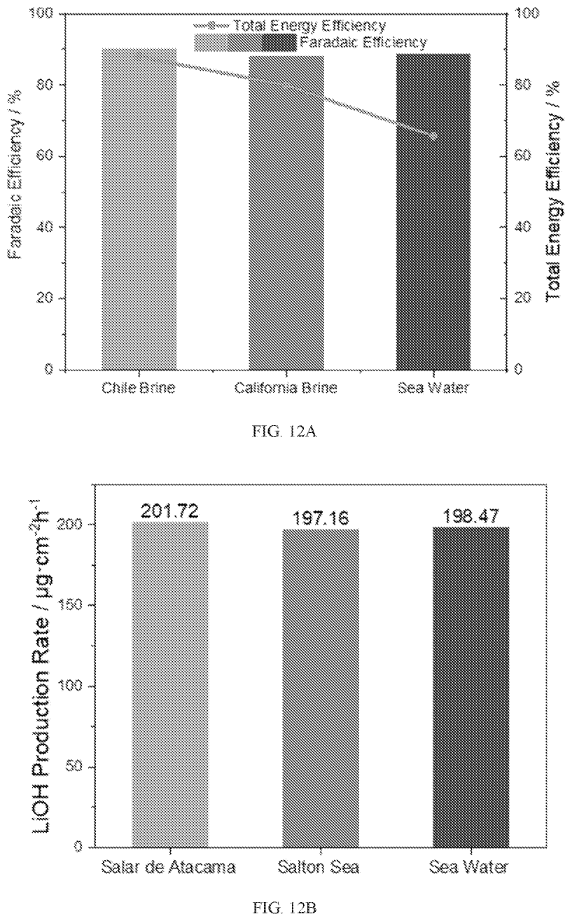

To show the applicability of the designed system to various lithium sources, both the artificial brine from the Salton Sea (geothermal brine) and the seawater taken directly from the Inner Harbor in Baltimore were applied as the anolyte. Compared with the Chilean brine (0.23M), the lithium concentrations in the Salton Sea Brine (0.024M) and seawater (0.2 ppm) are more diluted, inducing the higher lithium migration barrier and energy demand. In specific, during the test, the flow rate of seawater was improved to 100 sccm to guarantee a sufficient supplement of lithium. After testing at 0.25 mA·cm⁻² for 6 h (FIG. 11A), the extracted LiOH amount of 1182.9 μg·cm²_{membrane} and 1190.8 μg·cm²_{membrane} can be achieved from Salton Sea brine and seawater, respectively. The concentration of lithium in the Californian brine is about one-tenth of that in the Chilean brine, inducing the increasing cell voltage to 2.42 V and slightly decreased energy efficiency of ˜80% (FIG. 11B). Similarly, the cell voltage for LiOH production from seawater was improved to ˜3.1 V, which can be attributed to not only the diluted lithium concentration but also the harsh reaction kinetics of chlorine evolution because of the low concentration of chlorine. As a result, the energy efficiency of LiOH production from seawater is ˜65% (FIG. 12A). As shown in FIG. 12B, the lithium concentration will not have a significant effect on the LiOH production rate. Hence, for lithium recovery from unconventional sources by the designed electrochemical system, more attention needs to be paid to anode reaction kinetics instead of the diffusion competition among the cations.

### Example 2: Techno-Economic Analysis (TEA)

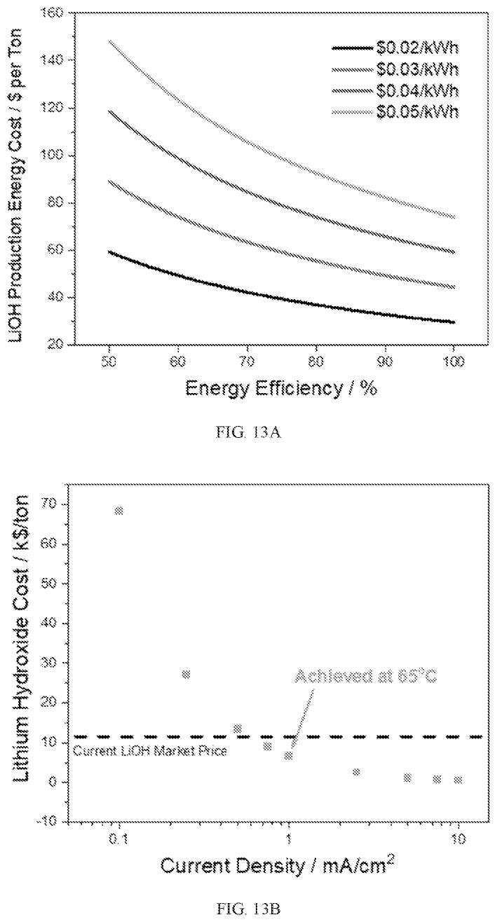

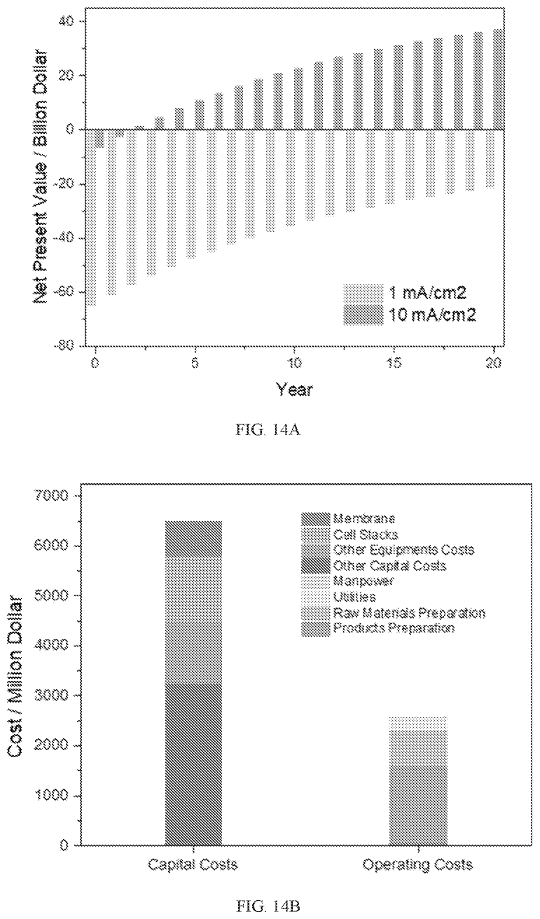

Techno-economic analysis (TEA) was performed to evaluate the marketing potential of the electrochemical lithium extraction technology. The TEA analysis of the processes followed the established model for chlor-alkali electrolyzer (but feeding in the data derived from lithium extraction experiments). The electricity cost of electrochemical lithium extraction system varies with different energy efficiency of the system and different electricity price. In general, the energy cost for lithium extraction in an independent chlor-alkali electrolyzer separated by LAGP membrane will be less than $150 per ton of produced LiOH with 50% energy efficiency at the highest electricity price of $0.05 per kWh (FIG. 13A). As shown in FIG. 13B, the preliminary TEA shows that, even at the present current density of 0.25 mA/cm², price of the produced LiOH is estimated to be ˜$26/kg. Also, employing a thinner LAGP membrane will decrease the migration distance of lithium ions so that can further reduce the resistance. It has previously been demonstrated that increasing the cell operating temperature will significantly benefit the ionic conductivity of the LAGP membrane. A preliminary test raising the operation temperature to 65° C. has shown that current density of >1 mA·cm⁻² is feasible for the electrochemical extraction. The price of the produced LiOH is estimated to be ˜$6.7/kg. However, the net present value (NPV) of the electrochemical lithium extraction process is estimated with two scenarios at 1 and 10 mA·cm⁻² current densities, as shown in FIG. 14A. The profitability of the process is hindered by the low current density, therefore elevating the current density to 10 mA cm² will lead the factory with 200 kton annual LiOH production capacity to be profitable after 2 years of operation. This is due to the high cost of the electrolyzer (membrane and stack), which is the major component of the capital cost (FIG. 14B), and it can be significantly reduced by running the process at high current density. It has previously reported that Garnet solid-state-electrolyte has the potential to operate at 13.3 mA·cm⁻² at room temperature (Zheng et al Adv. Funct. Mater. 2020, 30(6):1906189). Therefore, by further optimizing the cell design and operation conditions, the proposed extraction technology can be further improved to achieve efficient and selective production of the desired valuable products at target high current density and in a profitable way.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An electrodialysis apparatus, comprising:
an anode chamber comprising an anode and an anolyte, wherein the anolyte is a solution comprising lithium cations and chloride anions;
a cathode chamber comprising a cathode and a catholyte, wherein the catholyte is a solution comprising lithium hydroxide;
a Li⁺-selective cation exchange membrane operationally disposed between the anode chamber and the cathode chamber; and
a power source.

2. The apparatus of claim 1, wherein the anolyte solution comprises lithium chloride, lithium sulfate, lithium carbonate, lithium phosphate, lithium hexafluorophosphate, lithium perchlorate, lithium bis(trifluoromethanesulfonyl)imide, or a mixture thereof.

3. The apparatus of claim 1, wherein the anolyte is brine or seawater.

4. The apparatus of any one of claims 1-3, wherein the anode comprises an IrRu mixed-metal oxide.

5. The apparatus of any one of claims 1-4, wherein the Li⁺-selective cation exchange membrane comprises a lithium aluminum germanium phosphate.

6. The apparatus of any one of claims 1-5 wherein, in the anode chamber, the chloride ions are oxidized to chlorine gas.

7. The apparatus of any one of claims 1-6 wherein, in the cathode chamber, water is reduced to hydrogen gas and hydroxide ions.

8. The apparatus of any one of claims 1-7, wherein the cathode chamber does not comprise an organic electrolyte.

9. The apparatus of any one of claims 1-8, wherein the anode chamber further comprises an inlet for the anolyte and an outlet for spent anolyte.

10. The apparatus of any one of claims 1-9, wherein the cathode chamber further comprises an inlet for the catholyte and an outlet for a product lithium hydroxide solution.

11. The apparatus of any one of claims 1-10, wherein the power source is a source of renewable energy selected from solar energy or wind energy.

12. A method of producing lithium hydroxide, comprising:
providing an electrodialysis apparatus comprising an anode chamber, a cathode chamber, and a Li⁺-selective cation exchange membrane operationally disposed between the anode chamber and the cathode chamber, wherein the anode chamber comprises an anode and the cathode chamber comprises a cathode;
supplying an anolyte comprising lithium cations and chloride anions to the anode chamber;
supplying a catholyte to the cathode chamber; and
applying an electric potential to the electrodialysis apparatus via a power source, to thereby produce lithium hydroxide in the cathode chamber.

13. The method of claim 12, wherein the anolyte is a solution comprising lithium chloride, lithium sulfate, lithium carbonate, lithium phosphate, lithium hexafluorophosphate, lithium perchlorate, lithium bis(trifluoromethanesulfonyl)imide, or a mixture thereof.

14. The method of claim 12, wherein the anolyte is brine or seawater.

15. The method of any one of claims 12-14, wherein the anode comprises an IrRu mixed-metal oxide.

16. The method of any one of claims 12-15, wherein the Li⁺-selective cation exchange membrane comprises a lithium aluminum germanium phosphate.

17. The method of any one of claims 12-16 wherein, in the anode chamber, the chloride ions are oxidized to chlorine gas.

18. The method of any one of claims 12-17 wherein, in the cathode chamber, water is reduced to hydrogen gas and hydroxide ions.

19. The method of any one of claims 12-18, wherein the cathode chamber does not comprise an organic electrolyte.

20. The method of any one of claims 12-19, further comprising removing spent anolyte from the anode chamber.

21. The method of any one of claims 12-20, further comprising removing a product lithium hydroxide solution from the cathode chamber.

22. The method of claim 21, further comprising isolating the lithium hydroxide from the product solution via evaporation or precipitation.

23. The method of any one of claims 12-21, wherein the power source is a source of renewable energy selected from solar energy or wind energy.

24. The method of any one of claims 17-23, further comprising isolating the chlorine gas from the anode chamber and/or isolating the hydrogen gas from the cathode chamber.
